(19) United States
(12) Patent Application Publication
(10) Pub. No.: US 2018/0328503 A1
(43) Pub. Date: Nov. 15, 2018

(54) WALL-MOUNTED CHECK VALVE STRUCTURE

(71) Applicant: GREATNESS SANITARY INDUSTRIAL CO., Changhua (TW)

(72) Inventor: SONG-SHAN ZHONG, CHANGHUA (TW)

(21) Appl. No.: 15/592,147

(22) Filed: May 10, 2017

(51) Int. Cl. F16K 15/02; F16K 27/02

(52) U.S. Cl. CPC F16K 15/021; F16K 27/0209

(57) ABSTRACT

A wall-mounted check valve structure comprises a base and a connecting assembly. A flow tunnel is arranged at center of the base. An inner threading section is arranged at top of the flow tunnel. A first sealing sheet is arranged at top of the inner threading section. The connecting assembly includes a main body and a fixing seat. A connecting section is arranged in the main body. A stop surface is arranged at a lower side of the connecting section. The fixing seat has a head end and an outer threading section. Two sides of the fixing seat respectively have a plurality of water holes and a sealing piston. The sealing piston has a shielding section and a linking section. The linking section inserts into one of the water holes arranged at center of the fixing seat and the shielding section shields other water holes to make water flow unidirectionally.

### FIELD OF THE INVENTION

The present invention relates to a wall-mounted check valve structure, and more particularly to a structure which is assembled to a wall capable of preventing cold and hot water from flowing back.

### BACKGROUND OF THE INVENTION

The arrangement of water supply pipelines of a building is usually hidden in the wall or hidden by decorating to prevent the exposed water supply pipelines from influencing the beauty of interior space. The water supply pipelines are connected with the water instruments, such as faucet, shower unit, and toilet, with a check valve arranged therebetween. After the inlet of the check valve is screwed with the water supply pipelines, a soft pipe is screwed with the outlet pipe of the check valve and the inlet pipe of the water instruments to perform entire assembly. The pre-made water control member of the check valve is used to adjust the quantity of the water flowed into the water instruments. Especially the water instruments with cold and hot water, the cold water pipes and the hot water pipes are individually arranged so as to adjust the ration of the cold water and the hot water.

However, the conventional structure uses a valve structure arranged at the water supply pipelines. The valve structure has a sealing piston and a spring so as to spring back in the inlet pipe and prevent water from flowing back. But there are some disadvantages. Firstly, the sealing piston is slowly sprung back the sealing position. It is hard to immediately stop water to flow back. It may result in water flowing back the water supply pipelines. Secondly, the sealing piston is continuously rubbed against in the water supply pipelines to result in leaking water.

In view of the foregoing circumstances, the inventor has invested a lot of time to study the relevant knowledge, compare the pros and cons, research and develop related products. After quite many experiments and tests, the “wall-mounted check valve structure” of this invention is eventually launched to improve the foregoing shortcomings, to meet the public use.

### SUMMARY OF THE INVENTION

An objective of this invention is providing a wall-mounted check valve structure. A sealing piston which may be opened and closed be water flow is arranged in the fixing seat so that the water may flow toward the faucet. When the water flow is shut off, the sealing piston may reset to original position due to losing the push force.

To achieve above objective, a wall-mounted check valve structure comprises a base for connecting to a wall and a connecting assembly for connecting a faucet, characterized in that: a flow tunnel is arranged at a center of the base, an inner threading section is arranged at a top portion of the flow tunnel, a first sealing sheet is arranged at a top portion of the inner threading section; the connecting assembly includes a main body and a fixing seat, a connecting section is arranged in the main body for providing a faucet to screw and fix, a stop surface is arranged at a lower side of the connecting section, the fixing seat has a head end and an outer threading section, the fixing seat passes through the connecting section of the main body and screws with the inner threading section of the base with the outer threading section; and one side of the fixing seat adjacent to the base has a plurality of water holes and the other side thereof opposite to the outer threading section provides a sealing piston to seal, the sealing piston has a shielding section and a linking section, the linking section inserts into one of the water holes which is arranged at a center of the fixing seat to force the sealing piston to be limited in the fixing seat and the shielding section shields or covers other water holes to force water to flow unidirectionally, and a second sealing sheet is arranged on the head end of the fixing seat.

According to above mentioned structure, when turning on the faucet, the water is flowed from the base toward the outlet of the faucet and the water is flowed through the flow tunnel and the water holes of the fixing base to push the sealing piston so as to provide the water to the faucet. When the faucet is shut off, the water flow becomes weak so that the shielding section of the sealing piston shields or covers the water holes to prevent water from flowing back. In addition, the first sealing sheet and the second sealing sheet may prevent from leaking water. Therefore, the wall-mounted check valve structure of this invention may prevent water from flowing back and improve the service life.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a structural view of a wall-mounted check valve structure of the present invention.

FIG. 2 is an exploded view of the wall-mounted check valve structure of the present invention viewed from the bottom.

FIG. 3 is an exploded view of the wall-mounted check valve structure of the present invention viewed from the top.

FIG. 4 is a cross-sectional view of the wall-mounted check valve structure of the present invention.

FIG. 5 is an operational view of the wall-mounted check valve structure of the present invention.

FIG. 6 is an operational view of the wall-mounted check valve structure of the present invention while water flows.

### DESCRIPTION OF THE PREFERRED EMBODIMENT

Referring now to the drawings where like characteristics and features among the various figures are denoted by like reference characters.

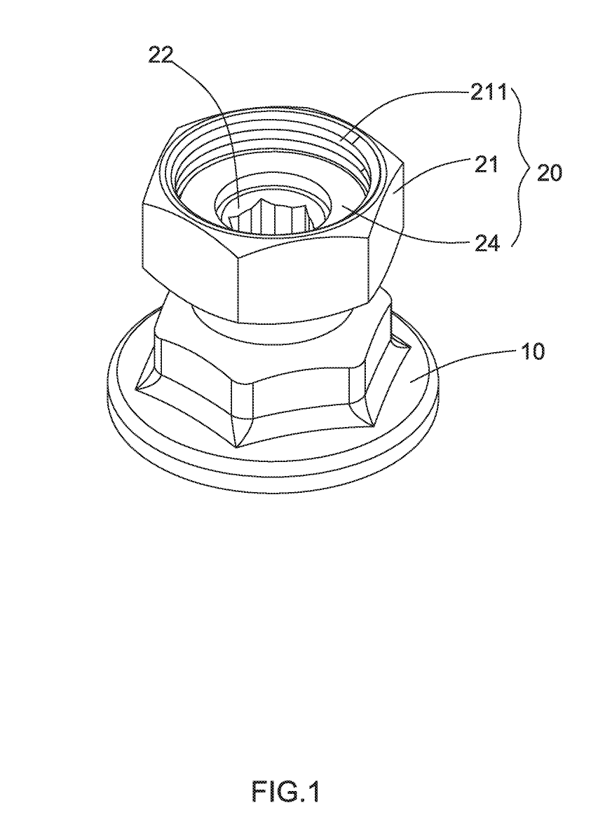

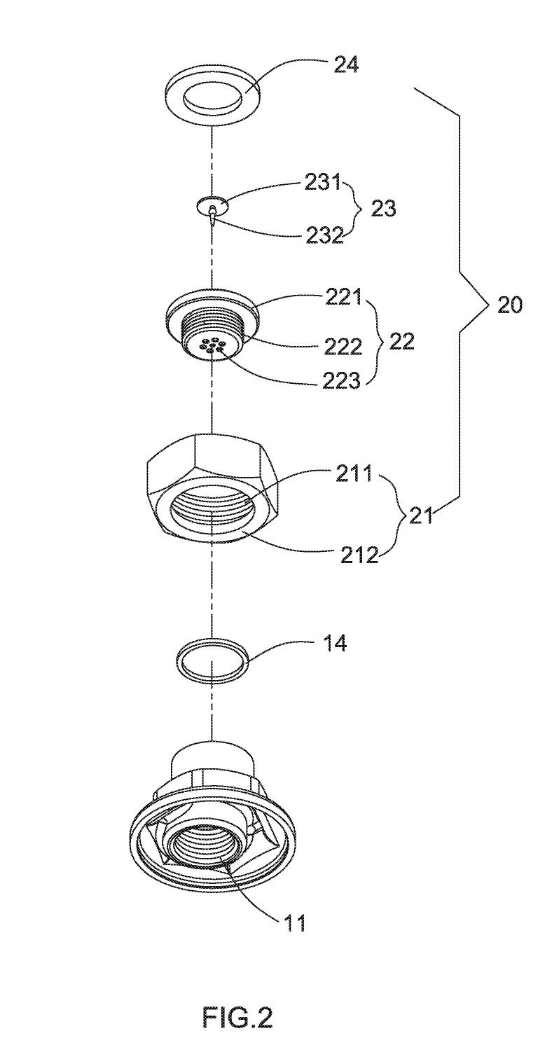

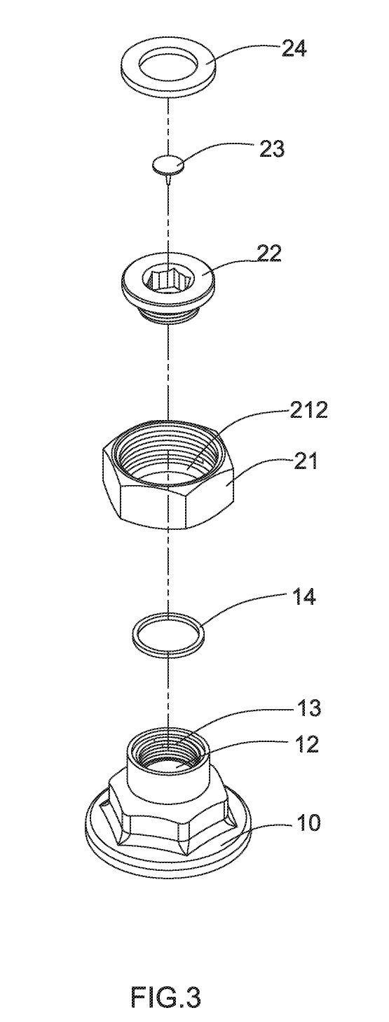

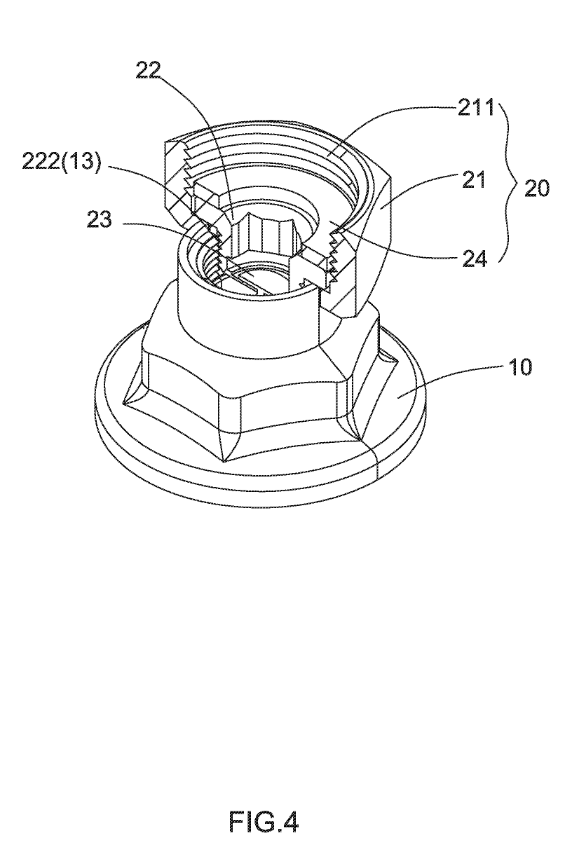

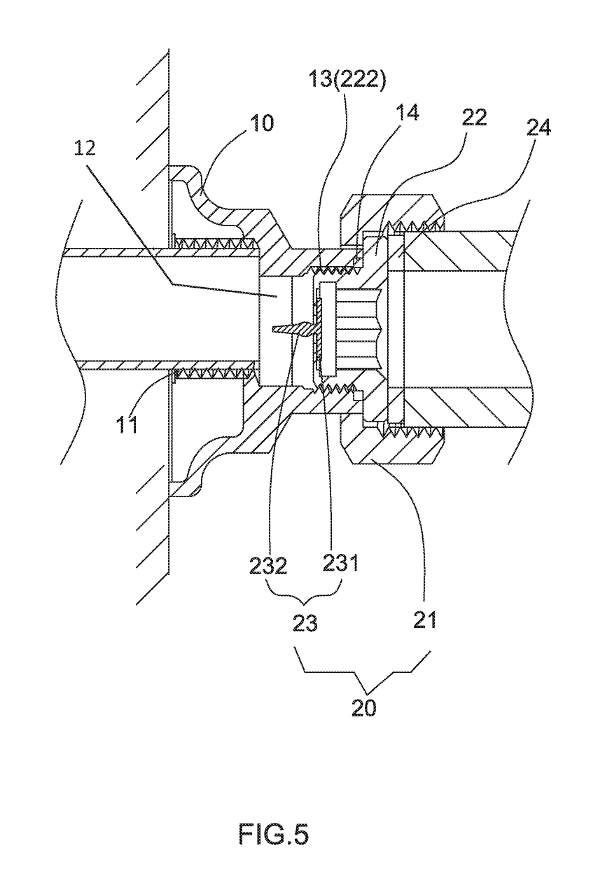

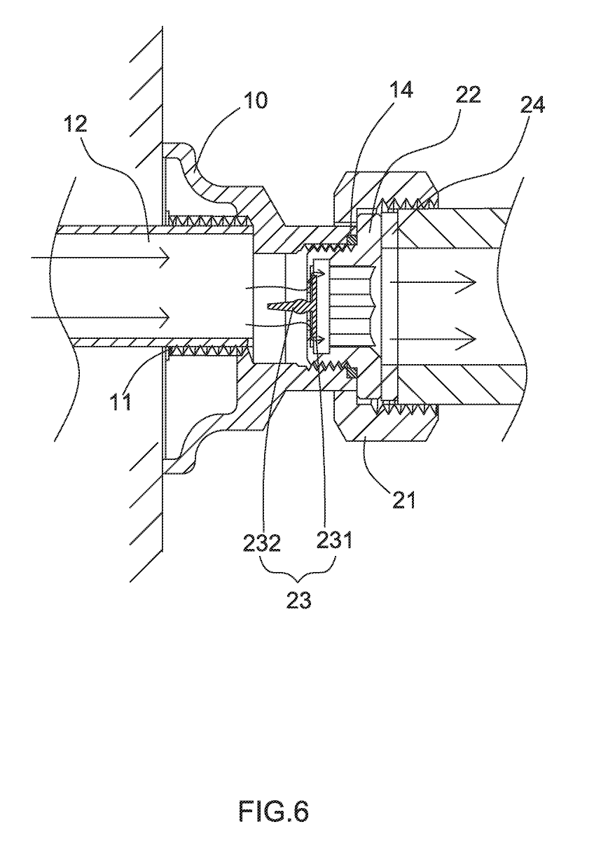

Please refer to FIGS. 1 to 6, a wall-mounted check valve structure may comprise a base 10 for connecting to a wall and a connecting assembly 20 for connecting a faucet.

Please refer to FIGS. 1 to 6, the base 10 may be assembled to the wall. A locking section 11 is arranged below the base 10 and connected with an inlet pipe of a building. A flow tunnel 12 is defined at a center of the base 10 for providing water to flow. An inner threading section 13 is arranged at a top portion of the flow tunnel 12 and a first sealing sheet 14 is arranged at a top portion of the inner threading section 13 for sealing water.

Please refer to FIGS. 1 to 6, the connecting assembly 20 may include a main body 21 and a fixing seat 22. A peripheral of the main body 21 is hexagonal. A connecting section 211 is arranged in the main body 12 for providing the faucet to screw and fix. The connecting assembly 20 and the faucet may be integrated to each other by a tool to drive the peripheral of the main body 21 to rotate. A stop surface 212 is arranged below the connecting section 211. When the fixing seat 22 of the connecting assembly 20 is connected to the base 10, the stop surface 212 may limit the fixing seat 22 so that the connecting assembly 20 may connect with the base 10 tightly. The fixing seat 22 has a head end 221 and an outer threading section 222. The head end 221 may just abut against the stop surface 212. The outer threading section 222 of the connecting assembly 20 may screw with the inner threading section 13 of the base 10. The first sealing sheet 14 may make the base 10 fix with the connecting assembly 20 tightly so as to prevent from leaking water. One side of the fixing seat 22 adjacent to the base 10 has a plurality of water holes 223 for guiding water to flow toward the faucet, and the other side thereof opposite to the outer threading section 222 has a sealing piston 23. The sealing piston 23 has a shielding section 231 and a linking section 232. The linking section 232 press-fits and inserts into one of the water holes which is arranged at a center of the fixing seat 22 to force the sealing piston 23 to be limited in the fixing seat 22 and the shielding section 232 shields or covers other water holes to force water to flow unidirectionally. A second sealing sheet 24 is arranged on the head end 221 of the fixing seat 22 to improve the tightness of seal to prevent from leaking water while the inlet pipe of the faucet connects with the connecting assembly 20.

Please refer to FIGS. 1 to 6, the practical operation of this invention is described as follows. Firstly, the inlet pipe of the faucet connects with the connecting assembly 20 after the connecting assembly 20 connects with the base 10. When turning on the faucet to guide water, water is flowed into the inlet pipe and the flow tunnel 12 in series. In this condition, the push force of the water flow is stronger so as to push the sealing piston 23 to make water flow through the water holes 223 toward the faucet. It may achieve the effect of providing water.

Please refer to FIGS. 1 to 6, when turning off the faucet, the water flow is weaker so that the shielding section 231 of the sealing piston 23 shields or covers the water holes 223 to immediately shield or cover the water holes 223 to prevent water from flowing back. Therefore, the wall-mounted check valve structure of this invention may prevent water from flowing back and improve the service life.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A wall-mounted check valve structure, comprising a base for connecting to a wall and a connecting assembly for connecting a faucet, characterized in that:
a flow tunnel is arranged at a center of the base, an inner threading section is arranged at a top portion of the flow tunnel, a first sealing sheet is arranged at a top portion of the inner threading section;
the connecting assembly includes a main body and a fixing seat, a connecting section is arranged in the main body for providing a faucet to screw, a stop surface is arranged at a lower side of the connecting section, the fixing seat has a head end and an outer threading section, the fixing seat passes through the connecting section of the main body and screws with the inner threading section of the base with the outer threading section; and
one side of the fixing seat adjacent to the base has a plurality of water holes and the other side thereof opposite to the outer threading section provides a sealing piston to seal, the sealing piston has a shielding section and a linking section, the linking section inserts into one of the water holes which is arranged at a center of the fixing seat to force the sealing piston to be limited in the fixing seat and the shielding section shields or covers other water holes to force water to flow unidirectionally, and a second sealing sheet is arranged on the head end of the fixing seat.
